(19) United States
(12) Patent Application Publication
(10) Pub. No.: US 2024/0396592 A1
(43) Pub. Date: Nov. 28, 2024

(54) METHOD FOR MODELING VISIBLE CLUSTERS AND NON-STATIONARITIES IN XL-MIMO SYSTEMS

(71) Applicant: Continental Automotive Technologies GmbH, Hannover (DE)

(72) Inventors: David Gonzalez Gonzalez, Egelsbach (DE); Osvaldo Gonsa, Frankfurt (DE); Andreas Andrae, Frankfurt am Main (DE); Giuseppe Thadeu Freitas de Abreu, Bremen (DE); Hiroki Iimori, Yokahama (JP)

(73) Assignee: Continental Automotive Technologies GmbH, Hannover (DE)

(21) Appl. No.: 18/290,797

(22) PCT Filed: Jul. 19, 2022
(86) PCT No.: PCT/EP2022/070202

§ 371 Date: Jan. 21, 2024

(30) Foreign Application Priority Data
Jul. 22, 2021 (DE) 10 2021 207 881.8

(51) Int. Cl. H04B 7/0413

(52) U.S. Cl. CPC H04B 7/0413

(57) ABSTRACT

Method for Modeling Visible Clusters and Non-stationarities in XL-MIMO systems configuring a plurality of transmit antennas to each represent an in-phase spatial constellation symbol within an in-phase spatial constellation, and a quadrature spatial constellation symbol within a quadrature spatial constellation, mapping source data to the in-phase spatial constellation symbols and the quadrature spatial constellation symbols represented by the plurality of transmit antennas, wherein the Matérn-cluster point process, which models randomly located clusters within a given area defines the area, where antenna arrays are embedded.

### FIELD

The present invention relates to the field of decoding digital communications in overloaded channels.

### BACKGROUND

There are three main challenges that need to be addressed by a so-called 5G wireless communication system to enable a truly “networked society,” where information can be accessed and data shared anywhere and anytime, by anyone and anything. These are:
A massive growth in the number of connected devices.
A massive growth in traffic volume.
An increasingly wide range of applications with varying requirements and characteristics.

To handle massive growth in traffic volume, wider frequency bands, new spectrum, and in some scenarios denser deployment are needed. Most of the traffic growth is expected to be indoor and thus indoor coverage is important.

The throughput and user capacity of wireless communication networks have improved exponentially over the last decade thanks to multiple-input multiple-output (MIMO) technologies, which will continue to play a key role in future systems. Indeed, only part of the attractiveness of massive MIMO systems in terms of spatial degrees of freedom (DoF), channel hardening, spectrum efficiency, inherent channel orthogonality, and massive array gains, are achieved in currently deployed systems.

As the scale and density of MIMO systems grow towards truly massive setups, however, besides infrastructure costs and various physical limitations, ideal assumptions such as antenna separation in the order of several wavelengths, full channel state information (CSI) knowledge, and perfectly spatially uncorrelated and abundantly diverse channels will become increasingly distant to reality.

Aiming at addressing these challenges, new concepts of distributed massive MIMO have been recently proposed, among which are cell-free MIMO (CF-MIMO) and extra large MIMO (XL-MIMO) systems. In a cell-free massive MIMO system, which can be seen as an instance of spatially distributed MIMO concept, a large number of access points (APs) geographically scattered over a certain service area and connected via fronthaul links to a common central processing unit (CPU), simultaneously serve multiple user equipments (UEs). Thanks to its spatial diversity, CF-MIMO are inherently robust to spatial correlation, but pay to that end the price of requiring either high-capacity fronthaul links or compression techniques, or both to mitigate the effects of limited fronthaul connections. In contrast, XL-MIMO systems can be said to follow the strategy of forming a “MIMO continuum”, in which a vastly large number of antennas are directly integrated into the ambient, by embedding them on the walls and ceilings of buildings, stadiums, train stations and airports. Since XL-MIMO systems rely on the use of large-aperture sub-arrays employed on a wide-ranging surface, XL-MIMO systems have to cope with its peculiarities including spatial non-stationarity, i.e., the fact that the signal from each user is apparent only to distributed portions of the XL-MIMO antenna array, referred to as its visibility region (VR).

One of the early attempts on capturing such effects is, where an analytical spherical-wave propagation model was considered to describe the non-planar wavefront due to the proximity between users and scatterers, relative to the Rayleigh distance of the entire array. Following the above, several works have been proposed. To mention a few, a user-grouping based approximated zero-forcing (ZF) precoding design was proposed for XL-MIMO beamforming in, which was shown to offer reasonable performance-complexity tradeoff.

Besides the above, another bottleneck of XL-MIMO systems has been argued in the State of the Art, which is the fact that due to the geographically distributed nature of XL-MIMO, only a portion of the total antennas can observe the signal from each user. Several studies have been presented to address this spatial non-stationarity in XL-MIMO from different aspects. The channel estimation (CE) problem in XL-MIMO subjected to non-stationarity was considered, while implicitly assuming a grant-based access protocol. An expectation propagation (EP)-based multiuser data detection mechanism for XL-MIMO systems was proposed, while an array selection method for higher energy efficient communications in XL-MIMO settings was also proposed. From an access viewpoint, a grant-based random access strategy for XL-MIMO systems was considered assuming perfect knowledge of active user indices. A theoretical interpretation of achievable throughput in uplink XL-MIMO systems has already been described.

Turning the attention away from system, back to access perspectives, let's consider the key role to be played by grant-free (GF) access technology in enabling future ultra reliable low latency communications (URLLC) and massive machine type communications (mMTC). Indeed, GF access schemes can significantly reduce overhead compared to conventional (grant-based) access schemes, requiring on the other hand joint activity and channel estimation (JACE) to be feasible.

A popular approach to design JACE schemes is the covariance-based method, where active user detection (AUD) is carried out by taking advantage of the sample covariance of the instantaneous received signal, followed by conventional CE, given the estimated active user indices. Another major approach is the machine learning (ML)-aided method, an example of which is the proposed scheme, where a deep neural network (DNN) was employed to perform JACE. The other promising approach is the Bayesian-based JACE mechanism, in which an approximated (linear) loopy belief propagation (BP) algorithm is leveraged to accomplish the JACE task. The inventors recently showed that emerging bilinear Bayesian inference frameworks can be employed to perform Bayesian-based JACE for GF access, with advantages over earlier linear Bayesian inference methods.

In this application a contribute to both aforementioned topics by proposing a novel JACE method for GF XL-MIMO systems. In particular, a design for a bilinear inference method to jointly estimate channel coefficients is disclosed as well as user and sub-array activities (i.e., non-stationarity) in an XL-MIMO setting, which to the best of the knowledge is the first in the State of the Art.

Although there are several attempts at modeling spatial non-stationarities, to the best of our knowledge, no modeling method for spatial non-stationarities via stochastic geometry has not been known yet. This invention provides a solution using a completely different approach, i.e., stochastic geometry.

Most of existing approaches considered uniformly random active patterns to capture the visible clusters in XL-MIMO systems. However, this approach is not capable of describing agglomerative nature of such clusters, i.e., existing solutions fail in capturing the real nature of the phenomena. We attempt to address this issue by using cluster point process via stochastic geometric modeling.

This invention proposes a model for partial visible clusters in extra-large massive multiple-input multiple-output (XL-MIMO) systems subject to spatial non-stationarity. When antenna arrays are embedded on the walls and ceilings of buildings, stadiums, train stations, and airports, the signal from each user is apparent only to specific portions of the XL-MIMO antenna array. This invention provides a solution to emulate these phenomena by exploiting stochastic geometry.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide in order to medelling XL-MIMO systems.

A New XL-MIMO Model is described. Non-stationarity, user activity patterns, and channel fading jointly imposes a new estimation problem of random variables following a nested Bernoulli-Gaussian distribution, which is captured in the system section of this application. To the best of our knowledge, this formulation appears for the first time in the literature.

A new tractable JACE Approach is described. Owing to the nested nature of the variables of interest, the JACE problem is decoupled into a tractable bilinear inference problem.

Furthermore, a new efficient JACE method is described. In order to solve the reformulated bilinear estimation problem, a novel message passing rule has been derived, in which estimates are obtained in closed-form. Based on the derived message passing rules, an iterative JACE method is proposed for GF XL-MIMO systems subject to non-stationarity.

A new XL-MIMO Non-stationarity system is disclosed. In order to capture the cluster-like nature of subarray activities, unlike the existing literature, a Matérn-cluster point process (MCPP)-based sub-array activity system is described, based on which the estimation performance of different approaches is compared.

The solution is based on cluster point processes, a technique from stochastic geometry. To be more precise, this invention proposes to exploit the Matérn-cluster point process, which models randomly located clusters within a given area (i.e., the area where antenna arrays are embedded). The main idea is modeling spatial non-stationarities observed in XL-MIMO systems via such a cluster point process. This approach is non-obvious for skill person in the art and enables us to capture the agglomerative nature of visible clusters, see the FIG. 1 below for illustrative examples of such visible clusters, where the signal from each user can be observed only at particle arrays. The idea is to map the scenario-specific characteristics onto the Matérn-cluster point process parameters to obtain the desired users' clusterization. Based on this method, further design assumptions for future XL-MIMO systems can be made. Better modeling (closer to reality), easy-to-implement, flexibility in modeling different specific scenario conditions, e.g., size of clusters, correlation, etc. The proposed method could find application in future wireless systems where XL-MIMO is applied, e.g., 5G+, 6G.

One preferred embodiment solving the described problem is a method for modeling visible clusters and non-stationarities in XL-MIMO systems configuring a plurality of transmit antennas to each represent an in-phase spatial constellation symbol within an in-phase spatial constellation, and a quadrature spatial constellation symbol within a quadrature spatial constellation, mapping source data to the in-phase spatial constellation symbols and the quadrature spatial constellation symbols represented by the plurality of transmit antennas, wherein the Matérn-cluster point process, which models randomly located clusters within a given area defines the area where antenna arrays are embedded.

Another preferred embodiment of the invention is characterized by a method wherein a modification to the iterative shrinkage-thresholding algorithm (ISTA) via boxing with range limiting and hard-thresholding is proceeded.

Another embodiment is characterized by a method, using the boxed-hard iterative shrinkage-thresholding algorithm (ISTA), a greedy selection of the positions of the antennas index and the symbol estimates, and their independent decoding of the corresponding antenna modulated and symbol modulated bits is determined.

A further embodiment of the method is characterized by a process working parallel to the greedy detections, to ensure valid estimates of the index vectors from the given finite set of index vectors are produced at the output of the method, and to apply interference cancellation with the confirmed values, while keeping track of which indices have been retrieved from the greedy selections, before every iteration a check is performed whether from the currently decoded indices, a final confirmation can be made, if the final confirmation cannot be made, remove the interference by the previous greedy selection and the next iteration is proceeded.

An embodiment of the invention is characterized by a receiver (R) of a communication system having a processor, volatile and/or non-volatile memory, at least one interface adapted to receive a signal in an communication channel, wherein the non-volatile memory stores computer program instructions which, when executed by the microprocessor, configure the receiver to implement the described methods above.

The described problem is solved by a computer program product comprising computer executable instructions, which, when executed on a computer, cause the computer to perform the method described above.

The described problem is solved by a computer-readable medium storing and/or transmitting the computer program product cited before.

### BRIEF DESCRIPTION OF THE DRAWINGS

For a fuller understanding of the nature of the present invention, reference should be had to the following detailed description taken in connection with the accompanying drawings. So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and are therefore not to be considered limiting of its scope, for the description may admit to other equally effective aspects.

FIG. 1 shows an illustration of the uplink of a multiuser XL-MIMO system with spatial non-stationarity, whereby each user independently activates different subarrays of 10 the XL-MIMO array depending propagation conditions

FIG. 2a, b shows the NMSE performance with respect to SNR with N=400 and M=200 for different pilot lengths

FIG. 3 shows AER performance with respect to SNR with N=400 and M=200 for different pilot lengths

FIG. 4 shows the resilience of the proposed algorithm against different sub-array activity indicators in perce

FIG. 5 shows the convergence behavior of the proposed algorithm with respect to the number of algorithmic iterations.

FIG. 6 shows the MCPP-based subarray activity

FIG. 7 shows the uniformly random subarray activity.

FIG. 8a, b, c shows the NMSE Performance with respect to SNR with N=400, M=200, and L=70 with MCPP for different μ.

FIG. 9a, b, c shows the AER Performance with respect to SNR with N=400, M=200, and L=70 with MCPP for different μ.

FIG. 10 shows the NMSE performance of the proposed method for different cluster intensities. The actual array activity ratios for μ=3, 6 and 9 are annotated by allows.

FIG. 11 shows the NMSE performance of the proposed method for different cluster radius sizes. The actual array activity ratios for μ=3, 6 and 9 are annotated by allows.

### DETAILED DESCRIPTION

Extra large MIMO (XL-MIMO) systems are subject to spatial non-stationarity which leads to a doubly-sparse and user-specific structure of received signals, such that the activity of each user at each sub-array can be characterized by a nested Bernoulli-Gaussian distribution. This application considers the joint activity and channel estimation (JACE) problem in XL-MIMO systems subject to spatial non-stationarity, offering two major embodiments solving this problem.

The first is a novel bilinear Bayesian inference method capable of jointly estimating sub-array activity patterns (a.k.a. spatial non-stationarity), user activity patterns, and associated channel coefficients, boosted by expectation maximization (EM)-based auto-parameterization.

The second embodiment is the introduction of realistic Poisson point process (PPP) and Matérn-cluster ' point process (MCPP) stochastic-geometry (SG) models to simulate sub-array activity patterns, which enables the performance assessment of both the proposed and state-of-the-art (SotA) XL-MIMO JACE solutions under different conditions in a structured manner. The efficacy of the proposed bilinear

JACE method is confirmed by numerical simulations, which shows that the proposed method not only significantly outperforms the SotA but also can reach the performance of a genie-aided (theoretical) scheme over wide signal-to-noise-ratio (SNR) ranges.

A Matérn cluster point process is a type of cluster point process, meaning that its randomly located points tend to form random clusters. Using techniques from spatial statistics, it is possible to make the definition of clustering more precise. This point process is an example of a family of cluster point processes known as Neyman-Scott point processes, which have been used in spatial statistics and telecommunications.

The Matérn cluster point process should not be confused with the Matérn hard-core point process, which is a completely different type of point process. Bertril Matérn proposed at least four types of point processes, and his name also refers to a specific type of covariance function used to define Gaussian processes.

Simulating a Matérn cluster point process requires first simulating a homogeneous Poisson point process with an intensity λ>0 on some simulation window, such as a rectangle, which is the simulation window I will use here. Then for each point of this underlying point process, simulate a Poisson number of points with mean μ>0 uniformly on a disk with a constant radius r>0. The underlying point process is sometimes called the parent (point) process, and its points are centres of the cluster disks.

The subsequent point process on all the disks is called daughter (point) process and it forms the clusters. It has been known about simulating the homogeneous Poisson point processes on a rectangle and a disk, so those posts are good starting points, and it won't not be focused too much on details for these steps.

The main challenge behind sampling this point process, is that it's possible for daughter points to appear in the simulation window that come from parents points outside the simulation window. In other words, parents points outside the simulation window contribute to points inside the window. To remove these edge effects, the point processes must be simulated on an extended version of the simulation window. Then only the daughter points within the simulation window are kept and the rest are removed. Consequently, the points are simulated on an extended window, but we only see the points inside the simulation window.

To create the extended simulation window, you can add a strip of width r all around the simulation window. The distance r is the maximum distance from the simulation window that a possibly contributing parent point (outside the simulation window) can exist, while still having daughter points inside the simulation window. This means it is impossible for a hypothetical parent point beyond this distance (outside the extended window) to generate a daughter point that can fall inside the simulation window. Simulate the underlying or parent Poisson point process on the rectangle with NP points. Then for each point, simulate a Poisson number of points, where each disk now has Di number of points. Then the total number of points is simply N=D1+ . . . +DP=ΣNPi=1Di. The random variables P and Di are Poisson random variables with respective means λA and μ, where A is the area of the rectangular simulation window. To simulate these random variables in MATLAB, the poissrnd function is used. To do this in R, use the standard function rpois. In Python, it can be used either functions scipy.stats.poisson or numpy.random.poisson from the SciPy or NumPy libraries.

The points of the parent point process are randomly positioned by using Cartesian coordinates. For a homogeneous Poisson point process, the x and y coordinates of each point are independent uniform points, which is also the case for the binomial point process, covered in a previous post. The points of all the daughter point process are randomly positioned by using polar coordinates. For a homogeneous Poisson point process, the θ and ρ coordinates of each point are independent variables, respectively with uniform and triangle distributions, which was covered in a previous post. Then we convert coordinates back to Cartesian form, which is easily done in MATLAB with the pol2cart function. In programming languages without such a function: x=ρ cos(θ) and y=ρ sin(θ).

In practice, all the daughter points are simulated in a disk with its centre at the origin. Then for each cluster disk, all the points have to be shifted to the origin is the center of the cluster, which completes the simulation step.

To use vectorization in the code, the coordinates of each cluster point are repeated by the number of daughters in the corresponding cluster by using the functions repelem in MATLAB, rep in R, and repeat in Python.

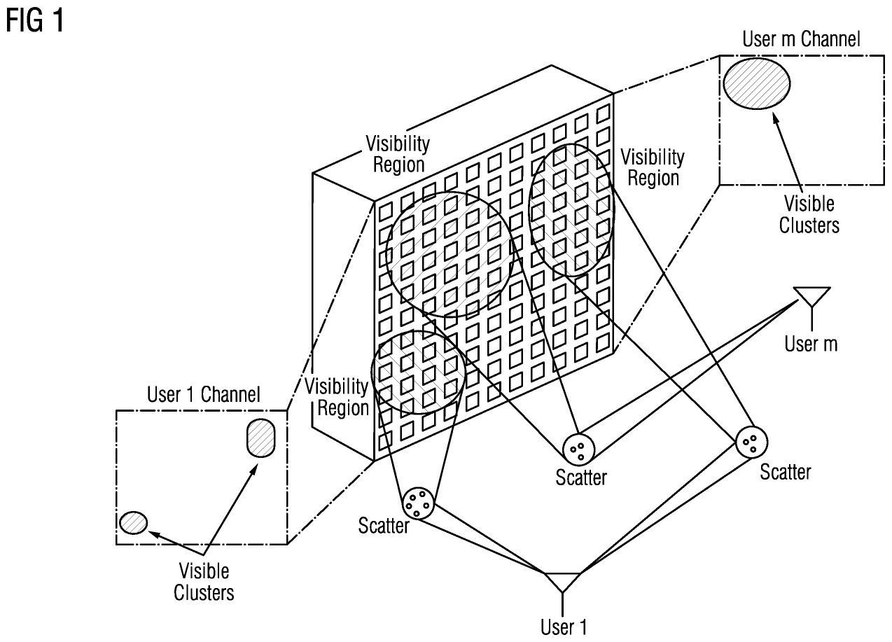

FIG. 1 shows an illustration of the uplink of a multiuser XL-MIMO system with spatial non-stationarity, whereby each user independently activates different subarrays of the XL-MIMO array depending propagation conditions

### SYSTEM MODEL DESCRIPTION

Consider an XL-MIMO system consisting of S sub-arrays, each equipped with Nₛ antenna elements, such that the total number of antenna array elements is given by N=Σₛ₌₁^{S}Nₛ, and let G∈C^{N×M} be the effective channel matrix between the XL-MIMO array and M single-antenna users, which jointly depicts user activities, sub-array VRs, and the fading gains. Then, the corresponding system model as shown in FIG. 1 is given by

$$Y = G X + W ∈ {ℂ}^{N \times L} , \qquad ( 1 )$$

where X∈C^{M×L} is a pilot matrix collecting the L signals transmitted by each user, while W∈C^{N×L} denotes zero-mean unit-variance independent and identically-distributed (iid) additive white Gaussian noise (AWGN) such that vec (W)˜ [symbol] [symbol] (0,σ²I).

In equation (1), it is assumed that only a small fraction of the M users is active, while the rest remains silent during the time interval of L transmissions. Letting K be a random variable that denotes the number of active users at a given time interval, the average user-activity probability can be expressed as λ≙ [symbol] [K/M]

Furthermore, owing to non-stationarities observed in the XL-MIMO setting, the channel matrix G possesses block-sparsity that captures both user activity and the sub-arrays in their VRs (i.e. active sub-arrays), such that the m-th column of G, relative to the m-th user, can be modeled as

$${g}_{m} = {a}_{m} \cdot {\tilde{g}}_{m} ⊙ {p}_{m} , \qquad ( 2 )$$

where ⊙ denotes the Hadamard (element-wise) product, αₘ∈{0,1} is the user activity indicator, \tilde{g}ₘ is the channel response vector, and pₘ≙[p₁ₘ, . . . , p_{Sm}]∈ [symbol] ^{N×1} denotes a sub-array activity indicator defined by

$${p}_{sm} {=}^{Δ} \{ \begin{matrix}{1}_{{N}_{s} \times 1} & \begin{matrix}if the s - th sub - array is in \\ the VR of the m - th user ,\end{matrix} \\ {0}_{{N}_{s} \times 1} & \begin{matrix}if the s - th sub - array is outside \\ the VR of the m - th user\end{matrix}\end{matrix} . \qquad ( 3 )$$

Assuming that \tilde{g}ₘ is Gaussian, as typically, the distribution of gₘ can be written as

$${g}_{m} ∼ {p}_{{g}_{m}} ( {g}_{m} ) {=}^{Δ} {\overbrace{( 1 - λ ) δ ( {g}_{m} )}}^{captures user activity} + λ {\overbrace{{\prod }_{s = 1}^{S} {\underbrace{f ( {g}_{Φ ( s ) m} \vert {ϕ}_{sm} , 0 , {Γ}_{sm} )}}_{\begin{matrix}captures fading \\ and sub - array activity\end{matrix}}}}^{jointing all sub - arrays} , \qquad ( 4 )$$

where δ(·) denotes the Dirac delta function, Γₛₘ is the covariance matrix of the m-th user's channel to the s-th sub-array, Φₛₘ depicts the mean activity of the s-th sub-array, with respect to the m-th user and

$$f ( z \vert ϕ , μ , \sum ) {=}^{Δ} ( 1 - ϕ ) δ ( z ) + ϕ \cdot ( μ , \sum ) , \qquad ( 5 )$$

where Φ is an active probability, μ denotes a certain mean, and Z is a given covariance matrix.

### JOINT ESTIMATION STRATEGY

In this section, we propose a novel bilinear message passing method for joint activity and channel estimation in XL-MIMO systems subjected to spatial non-stationarity. To this end, a decomposition of the system model given in equation (1) is carried out, followed by detailed derivations of message passing rules.

We remark that for the sake of generality, throughout the section it is assumed that the elements of the channel vectors \tilde{g}ₘ are independently but not identically distributed, which is equivalent to saying that the covariance matrices Γₛₘ are all diagonal, but have different norms. This is motivated by the fact that the VRs of each user at the XL-MIMO array in general result from the impinging of signals from different propagation paths, as illustrated in FIG. 1.

For the sake of future convenience, let us first reformulate equation (4) as

$$Y = HAX + W ∈ {ℂ}^{N \times L} , \qquad ( 6 )$$

with G≙HA∈ [symbol] ^{N×M}, where H∈ [symbol] ^{N×M}is the block fading channel matrix and the M×M diagonal matrix A, with diag (A)=[α₁, α₂, . . . , α_{M}] E{0,1}^{M}, captures user activity indicators.

For notation simplicity, we hereafter introduce the quantity v(s)≙Σᵢ₌₁^{s}Nᵢ, with v(0)≙=0, to denote the cumulative collection of sub-array antenna indices at the s-th sub-array. In order to gain a closer insight into the effect of non-stationarity onto the column vectors of the channel matrix H, consider the anatomized m-th column of H, which is given by

$${h}_{m} = {[ \overbrace{{p}_{{1}_{m}} {\overline{h}}_{Φ ( 1 ) m}^{T}}}^{1 st sub - array} , {\overbrace{{p}_{{2}_{m}} {\overline{h}}_{Φ ( 2 ) m}^{T} ,}}^{2 nd sub - array} … , {{\overbrace{{{p}_{S}}_{m} {\overline{h}}_{Φ ( S ) m}^{T}} ]}^{T}}^{S - th sub - array} , \qquad ( 7 )$$

where pₘₛ∈{0,1}, with s∈{1,2, . . . , S}, denotes the sub-array activity indicator, the vectors h̅_{Φ(s)m}˜ [symbol] [symbol] (0, Γₛₘ), and Φ(s)≙{v(s−1)+1, v(s−1)+2, . . . , v(s)} is a set of antenna indices corresponding to the s-th sub-array.

More conveniently, the m-th column and s-th sub-array of the channel matrix can be modeled as the Bernoulli-Gaussian random variable, that is,

$${h}_{Φ ( s ) m} ∼ {p}_{{h}_{Φ ( s ) m}} ( {h}_{Φ ( s ) m} ) {=}^{Δ} ( 1 - {ϕ}_{s m} ) δ ( {h}_{Φ ( s ) m} ) + {ϕ}_{s m} \cdot ( 0 , {Γ}_{s m} ) , \qquad ( 8 )$$

where Φₛₘ denotes the mean of pₘₛ.

From the above, one can readily notice that the problem of jointly estimating users and subarrays activity indicators, as well as channel coefficients, belongs to the class of bilinear inference problems. More precisely, given the received signal matrix Y and the predetermined reference signal matrix X, our goal is to jointly estimate αₘ, pₘₛ and h_{Φ(s)m} for all m∈{1,2, . . . , M} and s∈{1,2, . . . , S}, which are linearly multiplied by one another. In the next subsections we proceed to derive message passing rules designed to tackle this challenging problem, proposing a new joint activity and channel estimation for XL-MIMO subject to non-stationarity.

Focusing on the received signal element yₙₗ at the n-th row and l-th column of Y, the received signal after soft interference cancellation (Soft-IC) using tentative estimates can be written as

$$\text{} \begin{matrix}{\tilde{y}}_{m , n ℓ} = {y}_{n ℓ} - {\overbrace{{{\sum }_{ι \neq m}}^{M} {\hat{h}}_{ℓ , n ι} {\hat{a}}_{n ℓ , {ι}^{x} ι ℓ}}}^{Soft - IC} \\ = {h}_{n m} {a}_{m} {x}_{m ℓ} + {\overbrace{{\sum }_{ι \neq m}^{M} ( {h}_{n ι} {a}_{ι} - {\hat{h}}_{ℓ , n ι𝒶} {\hat{a}}_{n ℓ , ι} ) {x}_{ι ℓ} + {w}_{n ℓ} ,}}^{Residual interference plus noise}\end{matrix} \qquad ( 9 )$$

where the soft estimates [symbol] and [symbol] are generated in variable nodes at the previous iteration, while [symbol] denotes the noise element at the n-th row and [symbol] -th column of the AWGN matrix W.

Assuming that the residual interference plus noise component of equation (9) can be approximated as a complex Gaussian random variable in conformity to the central limit theorem, the conditional probability density function (PDF) of equation (9) for given hₙₘ can be written as

$${p}_{{\tilde{y}}_{m , n ℓ} \vert {h}_{nm}} ( {\tilde{y}}_{m , n ℓ} \vert {h}_{n m} ) ∝ exp ( - \frac{{\vert {\tilde{y}}_{m , n ℓ} - {h}_{n m} {\hat{a}}_{n ℓ , m} {x}_{m ℓ} \vert}^{2}}{{v}_{m , n ℓ}^{h}} ) , \qquad ( 10 )$$

where the error variance is given by

$$\text{} \begin{matrix}{v}_{m , n ℓ}^{h} = 𝔼 [ {\vert ( {a}_{m} - {\hat{a}}_{n ℓ , m} ) {h}_{n m} {x}_{m ℓ} + {\sum }_{i \neq m}^{M} ( {h}_{n i} {a}_{i} - {\hat{h}}_{ℓ , ni} {\hat{a}}_{n ℓ , i} ) {x}_{i ℓ} + {w}_{n ℓ} \vert}^{2} ] \\ = {ψ}_{n ℓ , m}^{a} {γ}_{n m} {\vert {x}_{m ℓ} \vert}^{2} + \\ {\underbrace{{\sum }_{i \neq m}^{M} ( {\vert {\hat{h}}_{ℓ , ni} \vert}^{2} {ψ}_{n ℓ , i}^{a} + ( {\vert {\hat{a}}_{n ℓ , i} \vert}^{2} + {ψ}_{n ℓ , i}^{a} ) {ψ}_{ℓ , ni}^{h} ) {\vert {x}_{i ℓ} \vert}^{2} + {σ}^{2} ,}}_{{=}^{Δ} {v}_{m , n ℓ}^{y}}\end{matrix} \qquad ( 11 )$$

with γₙₘ denoting the variance of the n-th row and m-th column of H, and where we implicitly defined the residual error variance [symbol] , for future convenience.

Similarly, the conditional PDF of [symbol] given am can be approximated as

$${p}_{{\hat{y}}_{m . n ℓ} \vert {a}_{m}} ( {\tilde{y}}_{m , n ℓ} \vert {a}_{m} ) ∝ exp ( - \frac{\vert {\tilde{y}}_{m , n ℓ} - {\hat{h}}_{ℓ , n m} {a}_{m} {x}_{m ℓ} {\vert}^{2}}{{v}_{m , n ℓ}^{a}} ) , \qquad ( 12 )$$

with variance given by

$$\begin{matrix}{v}_{m , n ℓ}^{a} = 𝔼 [ {\vert ( {h}_{n m} - {\hat{h}}_{ℓ , n m} ) {a}_{m} {x}_{m ℓ} + {\sum }_{i \neq m}^{M} ( {h}_{n i} {a}_{i} - {\hat{h}}_{ℓ , ni} {\hat{a}}_{n ℓ , i} ) {x}_{i ℓ} + {w}_{n ℓ} \vert}^{2} ] \\ = {ψ}_{ℓ , n m}^{h} λ {\vert {x}_{m ℓ} \vert}^{2} + {\sum }_{i \neq m}^{M} ( {\vert {\hat{h}}_{ℓ , ni} \vert}^{2} {ψ}_{n ℓ , i}^{a} + ( {\vert {\hat{a}}_{n ℓ , i} \vert}^{2} + {ψ}_{n ℓ , i}^{a} ) {ψ}_{ℓ , ni}^{h} ) {\vert {x}_{i ℓ} \vert}^{2} + {σ}^{2} ,\end{matrix} \qquad ( 13 )$$

where we utilized the fact that E[a²ₘ]=E[aₘ] =λ, since aₘ∈{0, 1}.

### Variable Node

Taking advantage of the Soft-IC mechanism and its resultant statistics shown above, the beliefs corresponding to the s-th sub-array combined over all available time resources except the [symbol] -th time index, yields the PDF of the extrinsic belief [symbol] given h_{Φ(s)m}, which is given by

$${p}_{{ξ}_{ℓ , Φ ( s ) m} \vert {h}_{Φ ( s ) m}} ( {ξ}_{ℓ , Φ ( s ) m} \vert {h}_{Φ ( s ) m} ) = {\prod }_{n = v ( s - 1 ) + 1}^{v ( s )} {\prod }_{i \neq l}^{L} {p}_{{\tilde{y}}_{m , ni} \vert {h}_{n m}} ( {\tilde{y}}_{m , n i} \vert {h}_{n m} ) ∝ {{\prod }_{n = v ( s - 1 ) + 1}}^{v ( s )} exp ( - \frac{{\vert {h}_{n m} - {μ}_{ℓ , n m}^{h} \vert}^{2}}{{θ}_{ℓ , n m}^{h}} ) ∝ 𝒞𝒩 ( {μ}_{ℓ , Φ ( s ) m}^{h} , {Θ}_{ℓ , Φ ( s ) m}^{h} ) , \qquad ( 14 )$$

with

$${μ}_{ℓ , Φ ( s ) m}^{h} {=}^{△} {[ {μ}_{ℓ , ( ν ( s - 1 ) + 1 ) m}^{h} , … , {μ}_{ℓ , v ( s ) m}^{h} ]}^{T} ∈ {ℂ}^{{N}_{s} \times 1} ; \qquad ( 15 a )$$

$${Θ}_{ℓ , Φ ( s ) m}^{h} {=}^{△} diag ( [ {θ}_{ℓ , ( v ( s - 1 ) + 1 ) m}^{h} , … , {θ}_{ℓ , v ( s ) m}^{h} ] ∈ {ℝ}^{{N}_{s} \times {N}_{s}} ; \qquad ( 15 b )$$

where

$${θ}_{ℓ , n m}^{h} {=}^{△} {( {\sum }_{i \neq ℓ}^{L} \frac{\vert {\hat{a}}_{n i , m} {x}_{m i} {\vert}^{2}}{{v}_{m , ni}^{h}} )}^{- 1} \qquad ( 16 a )$$

$${μ}_{ℓ , n m}^{h} = Δ {θ}_{ℓ , n m}^{h} {\sum }_{i \neq ℓ}^{L} \frac{{\tilde{y}}_{m , ni} {\hat{a}}_{ni , m}^{*} {x}_{m i}^{*}}{{v}_{m , ni}^{h}} \qquad ( 16 b )$$

In turn, the PDF of the extrinsic belief [symbol] given am can be similarly obtained as

$${p}_{{ξ}_{n ℓ , m} \vert {a}_{m}} ( {ξ}_{n ℓ , m} \vert {a}_{m} ) = {\prod }_{j \neq n}^{N} {\prod }_{i \neq ℓ}^{L} {p}_{{\tilde{y}}_{m , ji} \vert {a}_{m}} ( {\tilde{y}}_{m , j i} \vert {a}_{m} ) ∝ exp ( - \frac{{\vert {a}_{m} - {μ}_{n ℓ , m}^{a} \vert}^{2}}{{θ}_{n ℓ , m}^{a}} ) ∝ 𝒞𝒩 ( {μ}_{n ℓ , m}^{a} , {θ}_{n ℓ , m}^{a} ) , \qquad ( 17 )$$

where

$${θ}_{n ℓ , m}^{a} {=}^{△} {( {\sum }_{j \neq n}^{N} {\sum }_{i \neq ℓ}^{L} \frac{{\vert {h}_{i , j {m}^{X} m i} \vert}^{2}}{{v}_{m , ji}^{a}} )}^{- 1} \qquad ( 18 a )$$

$${μ}_{n ℓ , m}^{a} {=}^{△} {θ}_{n ℓ , m}^{a} {\sum }_{j \neq n}^{N} {\sum }_{i \neq ℓ}^{L} \frac{{\tilde{y}}_{m , j i} {\hat{h}}_{i , jm}^{*} {x}_{m i}^{*}}{{v}_{m , ji}^{a}} \qquad ( 18 b )$$

Combining the PDF in equation (14) with the prior channel PDF in equation (8) yields the posterior distribution of the channel. Therefore, taking the expectation of h_{Φ(s)m} over the latter yields the corresponding soft estimate [symbol] at the [symbol] -th variable node, which is given by

$${\hat{h}}_{ℓ , Φ ( s ) m} = {\int }_{{h}_{Φ ( s ) m}} {h}_{Φ ( s ) m} \frac{{p}_{{ξ}_{ℓ , Φ ( s ) m} \vert {h}_{Φ ( s ) m}} ( {ξ}_{ℓ , Φ ( s ) m} \vert {h}_{Φ ( s ) m} ) {p}_{{h}_{Φ ( s ) m}} ( {h}_{Φ ( s ) m} )}{{\int }_{{h}_{Φ ( s ) m}^{′}} {p}_{{ξ}_{ℓ , Φ ( s ) m} \vert {h}_{Φ ( s ) m}^{′}} ( {ξ}_{ℓ , Φ ( s ) m} \vert {h}_{Φ ( s ) m}^{′} ) {p}_{{h}_{Φ ( s ) m}^{′}} ( {h}_{Φ ( s ) m}^{′} )} , \qquad ( 19 )$$

where the denominator in the integrand is introduced for normalization purposes.

The error covariance associated with [symbol] is given by

$${Ψ}_{ℓ , Φ ( s ) m}^{h} {=}^{△} diag ( {\int }_{{h}_{Φ ( s ) m}} {h}_{Φ ( s ) m} {h}_{Φ ( s ) m}^{H} \frac{{p}_{{ξ}_{ℓ , Φ ( s ) m} \vert {h}_{Φ ( s ) m}} ( {ξ}_{ℓ , Φ ( s ) m} \vert {h}_{Φ ( s ) m} ) {p}_{{h}_{Φ ( s ) m}} ( {h}_{Φ ( s ) m} )}{{\int }_{{h}_{Φ ( s ) m}^{′}} {p}_{{ξ}_{ℓ , Φ ( s ) m} \vert {h}_{Φ ( s ) m}^{′}} ( {ξ}_{ℓ , Φ ( s ) m} \vert {h}_{Φ ( s ) m}^{′} ) {p}_{{h}_{Φ ( s ) m}^{′} ( {h}_{Φ ( s ) m}^{′} )}^{′}} ) - diag ( {\hat{h}}_{ℓ , Φ ( s ) m} {\hat{h}}_{ℓ , Φ ( s ) m}^{H} ) , \qquad ( 20 )$$

such that [symbol] =diag ( [symbol] , [symbol] , . . . , [symbol] ).

In turn, the soft replica [symbol] of the user activity indicator can be similarly obtained as

$${\hat{a}}_{n ℓ , m} = {\sum }_{α ∈ \{ 0 , 1 \}} α \cdot \frac{{p}_{{ξ}_{n ℓ , m} \vert {a}_{m}} ( {ξ}_{n ℓ , m} \vert α ) {p}_{{a}_{m}} ( α )}{{\sum }_{{α}^{′} ∈ \{ 0 , 1 \}} {p}_{{ξ}_{n ℓ , m} \vert {a}_{m}} ( {ξ}_{n ℓ , m} \vert {α}^{′} ) {p}_{{a}_{m}} ( {α}^{′} )} . \qquad ( 21 )$$

with p_{α}_{ₘ}(·) denoting the Bernoulli probability mass function (PMF) with intensity λ, which is accompanied by its mean square error (MSE) given by

$${ψ}_{n ℓ , m}^{a} = {\sum }_{α ∈ \{ 0 , 1 \}} {α}^{2} \cdot \frac{{p}_{{ξ}_{n ℓ , m} \vert {a}_{m}} ( {ξ}_{n ℓ , m} \vert α ) {p}_{{a}_{m}} ( α )}{{\sum }_{{α}^{′} ∈ \{ 0 , ′ 1 \}} {p}_{{ξ}_{n ℓ , m} \vert {a}_{m}} ( {ξ}_{n ℓ , m} \vert {α}^{′} ) {p}_{{a}_{m}} ( {α}^{′} )} - {\hat{a}}_{n ℓ , m}^{2} . \qquad ( 22 )$$

In order to compute equations (19)-(22) above, it is essential to analyze the effective distributions [symbol] ( [symbol] |h_{Φ(s)m})pₕ_{_{Φ(s)m}}(h_{Φ(s)m}) and [symbol] ( [symbol] |α) p_{α}_{ₘ}(α) such that the resultant calculations become tractable. To that end, plugging equations (8) and (14) into the effective distribution of h_{Φ(s)m} yields

$$( 23 )$$

$${p}_{{ξ}_{ℓ , Φ ( s ) m} \vert {h}_{Φ ( s ) m}} ( {ξ}_{ℓ , Φ ( s ) m} \vert {h}_{Φ ( s ) m} ) {p}_{{h}_{Φ ( s ) m}} ( {h}_{Φ ( s ) m} ) = ( ( 1 - {ϕ}_{s m} ) δ ( {h}_{Φ ( s ) m} ) + {ϕ}_{s m} \cdot 𝒞𝒩 ( 0 , {Γ}_{s m} ) ) \times 𝒞𝒩 ( {μ}_{ℓ , Φ ( s ) m}^{h} , {Θ}_{ℓ , Φ ( s ) m}^{h} ) = ( 1 - {ϕ}_{s m} ) δ ( {h}_{Φ ( s ) m} ) \frac{exp ( - {μ}_{ℓ , Φ ( s ) m}^{h} {Θ}_{ℓ , Φ ( s ) m}^{h - 1} {μ}_{ℓ , Φ ( s ) m}^{h} )}{{π}^{{N}_{s} \vert {Θ}_{ℓ , Φ ( s ) m}^{h} \vert}} + {ϕ}_{s m} \frac{exp ( - {{μ}_{ℓ , Φ ( s ) m}^{h} ( {Γ}_{s m} + {Θ}_{ℓ , Φ ( s ) m}^{h} )}^{- 1} {μ}_{ℓ , Φ ( s ) m}^{h} )}{{π}^{{N}_{s} \vert {Γ}_{s m} + {Θ}_{ℓ , Φ ( s ) m}^{h} \vert}} \times {\underbrace{𝒞𝒩 ( {{Γ}_{s m} ( {Γ}_{s m} + {Θ}_{ℓ , Φ ( s ) m}^{h} )}^{- 1} {μ}_{ℓ , Φ ( s ) m}^{h} , {{Γ}_{s m} ( {Γ}_{s m} + {Θ}_{ℓ , Φ ( s ) m}^{h} )}^{- 1} {Θ}_{ℓ , Φ ( s ) m}^{h} )}}_{{=}^{△} f ( {h}_{Φ ( s ) m} \vert {μ}_{ℓ , Φ ( s ) m}^{h} , {Θ}_{ℓ , Φ ( s ) m}^{h} , {Γ}_{s m} )} .$$

Thus, the corresponding normalization factor can be written as

$${\int }_{{h}_{Φ ( s ) m}} {p}_{{ξ}_{ℓ , Φ ( s ) m} \vert {h}_{Φ ( s ) m}} ( {ξ}_{ℓ , Φ ( s ) m} \vert {h}_{Φ ( s ) m} ) {p}_{{h}_{Φ ( s ) m}} ( {h}_{Φ ( s ) m} ) = {\int }_{{h}_{Φ ( s ) m}} ( 1 - {ϕ}_{s m} ) δ ( {h}_{Φ ( s ) m} ) \frac{exp ( - {μ}_{ℓ , Φ ( s ) m}^{h} H {Θ}_{ℓ , Φ ( s ) m}^{h - 1} {μ}_{ℓ , Φ ( s ) m}^{h} )}{{π}^{{N}_{s} \vert {Θ}_{ℓ , Φ ( s ) m}^{h} \vert}} + {ϕ}_{s m} \frac{exp ( - {{μ}_{ℓ , Φ ( s ) m}^{h} ( {Γ}_{s m} + {Θ}_{ℓ , Φ ( s ) m}^{h} )}^{- 1} {μ}_{ℓ , Φ ( s ) m}^{h} )}{{π}^{{N}_{s} \vert {Γ}_{s m} + {Θ}_{ℓ , Φ ( s ) m}^{h} \vert}} {\overbrace{{\int }_{{h}_{Φ ( s ) m}} f ( {h}_{Φ ( s ) m} \vert {μ}_{ℓ , Φ ( s ) m}^{h} , {Θ}_{ℓ , Φ ( s ) m}^{h} , {Γ}_{s m} )}}^{= 1} = {ϕ}_{s m} \frac{exp ( - {μ}_{ℓ , Φ ( s ) m}^{h} {H ( {Γ}_{s m} + {Θ}_{ℓ , Φ ( s ) m}^{h} )}^{- 1} {μ}_{ℓ , Φ ( s ) m}^{h} )}{{π}^{{N}_{s}} \vert {Γ}_{s m} + {Θ}_{ℓ , Φ ( s ) m}^{h} \vert} {τ}_{ℓ , m s} , \qquad ( 24 )$$

where the activity detection factor [symbol] is given by

$${τ}_{ℓ , m s} {=}^{△} 1 + \frac{1 - {ϕ}_{s m}}{{ϕ}_{s m}} exp ( \text{} - {μ}_{ℓ , Φ ( s ) m}^{{h}^{H}} ( {Θ}_{ℓ , Φ ( s ) m}^{{h}^{- 1}} - {( {Γ}_{s m} + {Θ}_{ℓ , Φ ( s ) m}^{h} )}^{- 1} ) {μ}_{ℓ , Φ ( s ) m}^{h} + log ( \text{} \vert {Θ}_{ℓ , Φ ( s ) m}^{h - 1} {Γ}_{s m} + {I}_{{N}_{s}} \vert ) ) . \qquad ( 25 )$$

Taking advantage of equations (23) and (24), the soft replica of h_{Φ(s)m} at the [symbol] -th node can be re-written as

$${\overline{h}}_{ℓ , Φ ( s ) m} = \frac{{{Γ}_{s m} ( {Γ}_{s m} + {Θ}_{ℓ , Φ ( s ) m}^{h} )}^{- 1}}{{τ}_{ℓ , m s}} {μ}_{ℓ , Φ ( s ) m}^{h} , \qquad ( 26 )$$

while its MSE [symbol] ≙diag ( [symbol] , . . . , [symbol] ) can be expressed as

$${\overline{Ψ}}_{ℓ , Φ ( s ) m}^{h} = ( {τ}_{ℓ , ms} - 1 ) diag ( {\hat{h}}_{ℓ , Φ ( s ) m} {\hat{h}}_{ℓ , Φ ( s ) m}^{H} ) + \frac{{Θ}_{ℓ , Φ ( s ) m}^{h} {{Γ}_{sm} ( {Γ}_{sm} + {Θ}_{ℓ , Φ ( s ) m}^{h} )}^{- 1}}{{τ}_{ℓ , ms}} . \qquad ( 27 )$$

In turn, the effective distribution [symbol] ( [symbol] |α) p_{α}_{ₘ}(α) can be simplified to

$${p}_{{ξ}_{n ℓ , m} \vert} {a}_{m} ( {ξ}_{n ℓ , m} \vert α ) {p}_{{a}_{m}} ( α ) = exp ( - \frac{{\vert α - {μ}_{n ℓ , m}^{a} \vert}^{2}}{{θ}_{n ℓ , m}^{a}} ) \times {\overbrace{( λα + ( 1 - λ ) ( 1 - α ) )}}^{Bernoulli PDF with intensity λ} , \qquad ( 28 )$$

where α∈{0,1} and the associated normalization factor can then be written as

$${\sum }_{α ∈ \{ 0 , 1 \}} {{p}_{{ξ}_{n ℓ , m} \vert}}_{{a}_{m}} ( {ξ}_{n ℓ , m} \vert α ) {p}_{{a}_{m}} ( α ) = λexp ( - \frac{{\vert 1 - {μ}_{n ℓ , m}^{a} \vert}^{2}}{{θ}_{n ℓ , m}^{a}} ) + ( 1 - λ ) exp ( - \frac{{\vert {μ}_{n ℓ , m}^{a} \vert}^{2}}{{θ}_{n ℓ , m}^{a}} ) \qquad ( 29 )$$

Thus, the soft replica of αₘ can be obtained as

$$\begin{matrix}{\hat{a}}_{n ℓ , m} = {\sum }_{α ∈ \{ 0 , 1 \}} α \cdot \frac{{{p}_{{ξ}_{n ℓ , m} \vert}}_{{a}_{m}} ( {ξ}_{n ℓ , m} \vert α ) {p}_{{a}_{m}} ( α )}{{\sum }_{{α}^{′} ∈ \{ 0 , 1 \}} {p}_{{ξ}_{n ℓ , m} \vert {a}_{m}} ( {ξ}_{n ℓ , m} \vert {α}^{′} ) {p}_{{a}_{m}} ( {α}^{′} )} \\ = \frac{λexp ( - \frac{{\vert 1 - {μ}_{n ℓ , m}^{a} \vert}^{2}}{{θ}_{n ℓ , m}^{a}} )}{λexp ( - \frac{{\vert 1 - {μ}_{n ℓ , m}^{a} \vert}^{2}}{{θ}_{n ℓ , m}^{a}} ) + ( 1 - λ ) exp ( - \frac{{\vert {μ}_{n ℓ , m}^{a} \vert}^{2}}{{θ}_{n ℓ , m}^{a}} )} , \\ = {\overbrace{\frac{1}{1 + \frac{1 - λ}{λ} exp ( - ( \frac{{\vert {μ}_{n ℓ , m}^{a} \vert}^{2}}{{θ}_{n ℓ , m}^{a}} - \frac{{\vert 1 - {μ}_{n ℓ , m}^{a} \vert}^{2}}{{θ}_{n ℓ , m}^{a}} ) )}}}^{Weighted Sigmoid Function}\end{matrix}$$

and its error variance can be written as

$$\begin{matrix}{ψ}_{n ℓ , m}^{a} = {\sum }_{α ∈ \{ 0 , 1 \}} {α}^{2} \cdot \frac{{{p}_{{ξ}_{n ℓ , m} \vert}}_{{a}_{m}} ( {ξ}_{n ℓ , m} \vert α ) {p}_{{a}_{m}} ( α )}{{\sum }_{{α}^{′} ∈ \{ 0 , 1 \}} {p}_{{ξ}_{n ℓ , m} \vert {a}_{m}} ( {ξ}_{n ℓ , m} \vert {α}^{′} ) {p}_{{a}_{m}} ( {α}^{′} )} - {\hat{a}}_{n ℓ , m}^{2} \\ = \frac{\frac{1 - λ}{λ} exp ( - ( \frac{{\vert {μ}_{n ℓ , m}^{a} \vert}^{2}}{{θ}_{n ℓ , m}^{a}} - \frac{{\vert 1 - {μ}_{n ℓ , m}^{a} \vert}^{2}}{{θ}_{n ℓ , m}^{a}} ) )}{{( 1 + \frac{1 - λ}{λ} exp ( - ( \frac{{\vert {μ}_{n ℓ , m}^{a} \vert}^{2}}{{θ}_{n ℓ , m}^{a}} - \frac{{\vert 1 - {μ}_{n ℓ , m}^{a} \vert}^{2}}{{θ}_{n ℓ , m}^{a}} ) ) )}^{2}} ,\end{matrix}$$

from which it is readily found that 0≤ [symbol] ≤¼

### Learning Array Activity via Expectation Maximization

In this section, we consider an auto-parameterization approach aided by expectation maximization (EM) to learn sub-array activity indicators. Sub-array activity indicators Φₛₘ are dependent upon instantaneous propagation environments, which may be difficult to obtain in practice and may not be compensated by the long-term statistical knowledge. Following the argument in Appendix A, we therefore propose to find an estimate of Φₛₘ via

$${\hat{ϕ}}_{sm} = {arg max}_{{ϕ}_{sm}} {\sum }_{ℓ = 1}^{L} {\int }_{{h}_{Φ ( s ) m}} \frac{log ( {p}_{{h}_{Φ ( s ) m}} ( {h}_{Φ ( s ) m} ; {ϕ}_{sm} ) ) {p}_{{ξ}_{ℓ , Φ ( s ) m}} \vert {h}_{Φ ( s ) m} ( {ξ}_{ℓ , Φ ( s ) m} \vert {h}_{Φ ( s ) m} ) {p}_{{h}_{Φ ( s ) m}} ( {h}_{Φ ( s ) m} )}{{\int }_{{h}_{Φ ( s ) m}^{′}} {p}_{{ξ}_{ℓ , Φ ( s ) m} \vert {h}_{Φ ( s ) m}^{′}} ( {ξ}_{ℓ , Φ ( s ) m} \vert {h}_{Φ ( s ) m}^{′} ) {p}_{{h}_{Φ ( s ) m}^{′}} ( {h}_{Φ ( s ) m}^{′} )} , \qquad ( 32 )$$

with the maximization constrained to satisfying the first-order necessary condition

$${\sum }_{ℓ = 1}^{L} {\int }_{{h}_{{Φ ( s ) m}_{}}} \frac{d log ( {p}_{{h}_{Φ ( s ) m}} ( {h}_{Φ ( s ) m} ; {ϕ}_{sm} ) )}{d {ϕ}_{sm}} \frac{{{p}_{{ξ}_{ℓ , Φ ( s ) m} \vert}}_{{h}_{Φ ( s ) m}} ( {ξ}_{ℓ , Φ ( s ) m} \vert {h}_{Φ ( s ) m} ) {p}_{{h}_{Φ ( s ) m}} ( {h}_{Φ ( s ) m} )}{{\int }_{{h}_{Φ ( s ) m}^{′}} {p}_{{ξ}_{ℓ , Φ ( s ) m}} {\vert}_{{h}_{Φ ( s ) m}^{′}} ( {ξ}_{ℓ , Φ ( s ) m} \vert {h}_{Φ ( s ) m}^{′} ) {p}_{{h}_{Φ ( s ) m}^{′}} ( {h}_{Φ ( s ) m}^{′} )} = 0 , \qquad ( 33 )$$

where the derivative can be written as

$$\frac{d log ( {p}_{{h}_{Φ ( s ) m}} ( {h}_{Φ ( s ) m} ; {ϕ}_{sm} ) )}{d {ϕ}_{sm}} = \{ \begin{matrix}\frac{1}{ϕ sm} & if {h}_{Φ ( s ) m} \neq 0 \\ \frac{- 1}{1 - {ϕ}_{sm}} & if {h}_{Φ ( s ) m} = 0\end{matrix} \qquad ( 34 )$$

Treating the neighborhood around h_{Φ(s)m}=0 and the rest separately, equation (33) boils down to the following equality condition

which readily yields

$${\sum }_{ℓ = 1}^{L} \frac{1}{{ϕ}_{sm} {τ}_{ℓ , ms}} = {\sum }_{ℓ = 1}^{L} \frac{1}{1 - {ϕ}_{sm}} \frac{{τ}_{ℓ , ms} - 1}{{τ}_{ℓ , ms}} , \qquad ( 35 )$$

$${\hat{ϕ}}_{ms} = \frac{1}{L} {\sum }_{ℓ = 1}^{L} \frac{1}{{τ}_{ℓ , ms}} . \qquad ( 36 )$$

Assuming uniformity among sub-array activity indicators (i.e., Φ=Φₛₘ for all m and s), the above derivation can be further generalized to combine all available information over the spatial and user domains, namely,

$$\hat{ϕ} = {arg max}_{ϕ} {\sum }_{ℓ = 1}^{L} {\sum }_{m = 1}^{M} {\sum }_{s = 1}^{S} {\int }_{{h}_{Φ ( s ) m}} \frac{log ( {p}_{{h}_{Φ ( s ) m}} ( {h}_{Φ ( s ) m} ; ϕ ) ) {p}_{{ξ}_{ℓΦ ( s ) m}} {\vert}_{{h}_{Φ ( s ) m}} ( {ξ}_{ℓ , Φ ( s ) m} \vert {h}_{Φ ( s ) m} ) {p}_{{h}_{Φ ( s ) m}} ( {h}_{Φ ( s ) m} )}{{\int }_{{h}_{Φ ( s ) m}^{′}} {p}_{{ξ}_{ℓ , Φ ( s ) m}} {\vert}_{{h}_{Φ ( s ) m}^{′}} ( {ξ}_{ℓ , Φ ( s ) m} \vert {h}_{Φ ( s ) m}^{′} ) {p}_{{h}_{Φ ( s ) m}^{′}} ( {h}_{Φ ( s ) m}^{′} )} , \qquad ( 37 )$$

which finally yields

$$\hat{ϕ} = \frac{1}{MSL} {\sum }_{ℓ = 1}^{L} {\sum }_{m = 1}^{M} {\sum }_{s = 1}^{S} \frac{1}{{τ}_{ℓ , ms}} . \qquad ( 38 )$$

### Activity Detection Policy

Finally, in this subsection the last step is discussed, corresponding to the refinement of the user activity estimates according to a pre-defined user activity policy. Different approaches to perform this step can be considered. Here, we adopt the new log-likelihood ratio (LLR)-based approach taking both \grave{H} and À into consideration.

To that end, first recognize that the user activity pattern captured by the binary quantities on the diagonal elements of À can equivalently be expressed as column-sparsity of \grave{H}, which implies that an activity detection policy must jointly consider \grave{H} and À for AUD. Denoting the estimated effective channel matrix Ĝ≙ĤÂ, the element-wise LLR can be written as

$${Λ}_{nm} = log \frac{𝒞𝒩 ( 0 , {γ}_{nm} + {ψ}_{nm}^{h} \vert {\hat{g}}_{nm} )}{𝒞𝒩 ( 0 , {ψ}_{nm}^{h} \vert {\hat{g}}_{nm} )} . \qquad ( 39 )$$

From the above, the user activity can be detected by combining the LLRs Λₙₘ for all the receive antenna dimensions N. However, such a detection policy ignores the presence of the block-wise sparsity due to spatial non-stationarity, leading to detection performance degradation. To address this issue, the following sub-array activity aware AUD policy is considered.

$${\hat{a}}_{m} \{ \begin{matrix}1 & if {max}_{s} ( {\sum }_{n ∈ Φ ( s )} {Λ}_{nm} ) \geq 0 \\ 0 & otherwise .\end{matrix} \qquad ( 40 )$$

### Method 1 Bilinear Message Passing for JACE in XL-MIMO with Non-Stationarity

Inputs: Y and X, and initializers Ĥ and \hat{Ψ}^{h}_{,}
Outputs: Ĥ and Â
Internal Parameters: I′ₛₘ, \hat{ϕ}ₛₘ, σ², λ, η and tₘₐₓ
For all (n, m, [symbol] )
1: [symbol] (1) ← 0, [symbol] (1) ← 0
2: [symbol] (1) ← [Ĥ]ₙₘ, [symbol] (1) ← [\hat{Ψ}^{h}]ₙₘ
for t = 1, . . . , tₘₐₓ
For all (n, m, [symbol] )
3: Eq. (9): [symbol] ← [symbol] − Σ_{i≠m}^{M} [symbol] [symbol] [symbol]
4: Eq. (11): [symbol] ← Σ_{i≠m}^{M} (| [symbol] |² [symbol] + (| [symbol] |² + [symbol] ) [symbol] ) | [symbol] |² + σ²
5: [symbol] ← [symbol] γnm| [symbol] |² + [symbol]
6: Eq. (13): [symbol] ← [symbol] λ| [symbol] |² + [symbol]
$7 : Eq . ( 16 ) : {θ}_{ℓ , n m}^{h} ← {( {\sum }_{i \neq ℓ}^{L} \frac{{\vert {\hat{a}}_{ni , m} {x}_{m i} \vert}^{2}}{{v}_{m , ni}^{h}} )}^{- 1} and {μ}_{ℓ , n m}^{h} ← {θ}_{ℓ , n m}^{h} {\sum }_{i \neq ℓ}^{L} \frac{{\hat{y}}_{m , ni} {\hat{a}}_{ni , m}^{*} {x}_{m i}^{*}}{{v}_{m , ni}^{h}}$
$8 : Eq . ( 18 ) : {θ}_{n ℓ , m}^{a} ← {( {\sum }_{j \neq n}^{N} {\sum }_{i \neq ℓ}^{L} \frac{{\vert {\hat{h}}_{i , jm} {x}_{m i} \vert}^{2}}{{v}_{m , ji}^{a}} )}^{- 1} and {μ}_{n ℓ , m}^{a} ← {θ}_{n ℓ , m}^{a} {\sum }_{j \neq n}^{N} {\sum }_{i \neq ℓ}^{L} \frac{{\hat{y}}_{m , ji} {\hat{h}}_{i , jm}^{*} {x}_{m i}^{*}}{{v}_{m , ji}^{a}}$
$9 : Eq . ( 21 ) : {\hat{a}}_{n ℓ , m} ← ( 1 + \frac{1 - λ}{λ} exp ( - ( \frac{{\vert {μ}_{n ℓ , m}^{a} \vert}^{2}}{{θ}_{n ℓ , m}^{a}} - \frac{{\vert 1 - {μ}_{n ℓ , m}^{a} \vert}^{2}}{{θ}_{n ℓ , m}^{a}} ) ) )$
$10 : Eq . ( 22 ) : {ψ}_{n ℓ , m}^{a} ← \frac{1 - λ}{λ} exp ( - ( \frac{{\vert {μ}_{n ℓ , m}^{a} \vert}^{2}}{{θ}_{n ℓ , m}^{a}} - \frac{{\vert 1 - {μ}_{n ℓ , m}^{a} \vert}^{2}}{{θ}_{n ℓ , m}^{a}} ) ) {( 1 + \frac{1 - λ}{λ} exp ( - ( \frac{{\vert {μ}_{n ℓ , m}^{a} \vert}^{2}}{{θ}_{n ℓ , m}^{a}} - \frac{{\vert 1 - {μ}_{n ℓ , m}^{a} \vert}^{2}}{{θ}_{n ℓ , m}^{a}} ) ) )}^{- 2}$
For all (m, s, [symbol] )
11: Eq. (15): [symbol] ← [ [symbol] , . . . , [symbol] ]^{T}
12: [symbol] ← diag ([ [symbol] , . . . , [symbol] ])
$13 : Eq . ( 25 ) : {τ}_{ℓ , m s} ← 1 + \frac{( 1 - {\hat{ϕ}}_{s m} )}{{\hat{ϕ}}_{s m}} \frac{\vert {Γ}_{s m} + {Θ}^{h} ℓ , Φ ( s ) m \vert}{\vert {Θ}^{h} , Φ ( s ) m \vert} exp ( - {μ}_{ℓ , Φ ( s ) m}^{h} ( {Θ}_{ℓ , Φ ( s ) m}^{h - 1} - {( {Γ}_{s m} + {Θ}_{ℓ , Φ ( s ) m}^{h} )}^{- 1} ) {μ}_{ℓ , Φ ( s ) m}^{h} )$
$14 : Eq . ( 32 ) : {\hat{ϕ}}_{m s} = \hat{ϕ} ← \frac{1}{MSL} {\sum }_{ℓ = 1}^{L} {\sum }_{m = 1}^{M} {\sum }_{s = 1}^{S} \frac{1}{{τ}_{ℓ , m s}}$
$15 : Eq . ( 26 ) : {\overline{h}}_{ℓ , Φ ( s ) m} ← \frac{{{Γ}_{s m} ( {Γ}_{s m} + {Θ}_{ℓ , Φ ( s ) m}^{h} )}^{- 1}}{{τ}_{ℓ , m s}} {μ}_{ℓ , Φ ( s ) m}^{h}$
$16 : Eq . ( 27 ) : {\overline{Ψ}}_{ℓ , Φ ( s ) m}^{h} ← ( {τ}_{ℓ , m s} - 1 ) diag ( {\overline{h}}_{ℓ , Φ ( s ) m} {\overline{h}}_{ℓ , Φ ( s ) m}^{H} ) + \frac{{Θ}_{ℓ , Φ ( s ) m}^{h} {{Γ}_{s m} ( {Γ}_{s m} + {Θ}_{ℓ , Φ ( s ) m}^{h} )}^{- 1}}{{τ}_{ℓ , m s}}$
17: Damping [30]: [symbol] ← η [symbol] + (1 − η) [symbol]
18: [symbol] ← η [symbol] + (1 + η) [symbol]
end for
For all (n, m, [symbol] ), update [symbol] and [symbol] by repeating lines 3 to 6
$20 : For all ( n , m ) , Eq . ( 16 ) : {θ}_{n m}^{h} ← {( {\sum }_{i = 1}^{L} \frac{{\vert {\hat{a}}_{ni , m} {x}_{m i} \vert}^{2}}{{v}_{m , ni}^{h}} )}^{- 1} and {μ}_{n m}^{h} ← {θ}_{n m}^{h} {\sum }_{i = 1}^{L} \frac{{\hat{y}}_{m , ni} {\hat{a}}_{ni , m}^{*} {x}_{m i}^{*}}{{v}_{m , ni}^{h}}$
$21 : For all ( m , s ) , Eq . ( 26 ) : {\hat{h}}_{Φ ( s ) m} ← \frac{{{Γ}_{s m} ( {Γ}_{s m} + {Θ}_{Φ ( s ) m}^{h} )}^{- 1}}{{τ}_{m s}} {μ}_{Φ ( s ) m}^{h} ⇒ \hat{H}$
$22 : Refresh {θ}_{m}^{a} ← {( {\sum }_{j = 1}^{N} {\sum }_{i = 1}^{L} \frac{{\vert {\hat{h}}_{i , jm} {x}_{m i} \vert}^{2}}{{v}_{m , ji}^{a}} )}^{- 1} and {μ}_{m}^{a} ← {θ}_{m}^{a} {\sum }_{j = 1}^{N} {\sum }_{i = 1}^{L} \frac{{\tilde{y}}_{m , ji} {\hat{h}}_{i , jm}^{*} {x}_{m i}^{*}}{{v}_{m , ji}^{a}}$
$23 : Eq . ( 30 ) : refresh {\hat{a}}_{m} ← {( 1 + \frac{1 - λ}{λ} exp ( - ( \frac{{\vert {μ}_{m}^{a} \vert}^{2}}{{θ}_{m}^{a}} - \frac{{\vert 1 - {μ}_{m}^{a} \vert}^{2}}{{θ}_{m}^{a}} ) ) )}^{- 1}$
24: Eq. (40): make hard decision on am => A.

### Method Description

In this section we offer several remarks on the message passing and consensus mechanisms for JACE proposed above, which for convenience is concisely summarized in Algorithm 1. Referring to Algorithm 1, first notice that the procedure requires two initialization quantities, namely, initial values of the channel matrix \grave{H} and error covariance matrix \grave{Ψ}^{h}, which can be obtained via a number of state-of-the art methods, such as the AUD-aware approximate BP algorithm, adopted here due to its complexity-performance tradeoff advantages. Besides that, the proposed JACE algorithm takes as inputs the received signal matrix Y and the pilot matrix X; to which it outputs estimates of the channel matrix \grave{H} and of the user activity matrix Â. The algorithm has two essential stages, the iterative stage described by lines 3 to 18 within which the beliefs are propagated and exchanged between factor and variable nodes, and the consensus stage where the output quantities are finally determined based on the obtained beliefs, as summarized in lines 19 to 24. Notice that lines 17 and 18 correspond to a well-known damping procedure, which aims to avoid estimates being trapped at a local optimum, especially at the early stage of the iterations by allowing a slow update of the quantities [symbol] , [symbol] , [symbol] , and [symbol] .

This is due to the fact that at the early stage of the iterative process, the Gaussian approximation assumed in equation (9) may not capture the actual statistics of the effective noise, which might lead to convergence to a local optimum point.

Notice also that the consensus stage includes in line 22 a self-feedback step in which the sum operation without its performed index exclusion so as to yield the desired dimension of the variables of interest. It is also worth-noting that the number of iterations is fixed here to tₘₐₓ only for the sake of the complexity analysis to be offered later. In practice, the process can be terminated at a fewer (also adaptively-determined) number of iterations, resulting in lower total complexity. The possibility of reducing the number of iterations is studied later via the convergence behavior of the algorithm, where it is shown that approximately 9 iterations are sufficient for convergence, regardless of signal-to-noise-ratio (SNR) levels.

### SIMULATION RESULTS

In this part, the estimation performance of the proposed bilinear inference method under various system setups are assessed. In particular, the normalized mean square error (NMSE) and activity error rate (AER) are considered as key performance metrics to measure, respectively, the estimation accuracy of channel coefficients, as well as user activity indicators.

The NMSE and AER are respectively defined as

$$NMSE {=}^{Δ} \frac{{‖ HA - \hat{H} \hat{A} ‖}_{F}^{2}}{{‖ HA ‖}_{F}^{2}} , \qquad ( 41 )$$

$$AER {=}^{Δ} \frac{\vert 𝒜 \backslash \hat{𝒜} \vert}{M} \leq 1 , \qquad ( 42 )$$

where Ĥ and Â denoting estimated channel and user activity matrices, respectively, [symbol] denotes the true activity index set, |·| denotes the cardinality of a given set, and the operator \ denotes the relative complement, such that | [symbol] |≤M, | [symbol] |≤M, and | [symbol] \ [symbol] |≤M.

Throughout the section, the following parameters are utilized, unless specified otherwise. The number of total antenna elements and sub-arrays are respectively assumed to be N=400 and S=100, indicating that each sub-array possesses Nₛ=4 antenna elements. This setup can be interpreted as an XL-MIMO system consisting of multiple sub-arrays with each being a 2×2 patch antenna array, for instance. The total number of time indices and potential users is set to L={50,70} and M=200, respectively. The user activity ratio is assumed to be λ=0.1, while the number of active users at each channel realization is modeled as a binomial random variable with mean λM. The variance of channel coefficients is assumed to be identical and modeled as Φ=Φbₛₘ=1/M for all m and s, whereas different models for the non-stationarity phenomena are considered.

As for the algorithmic parameters, the maximum number of iterations is assumed to be tₘₐₓ=32, while the damping factor η is set to 0.5. The sub-array activity indicator Φ is automatically learned over iterations via the EM framework presented in Section III-D. It is assumed that initial estimates (i.e., Ĥ, \hat{Ψ}^{h}) are obtained via the low-complexity multiple measurement approximate belief propagation (MMVABP) algorithm.

### Comments on Complexity

Before presenting results on the actual performance of the proposed bilinear inference method for JACE, we analyze its computational complexity in terms of the number of floating point operations (flops) required at each iteration of the algorithm. Since all the calculations in Algorithm 1 are scalar-by-scalar and the required inverse operation is performed with a diagonal matrix, the number of multiplication, division, subtraction, and addition operations is of order [symbol] (NML), which is linear with respect to each of available resource dimensions. In Algorithm 1, the number of iterations is set to tₘₐₓ, implying that the total complexity is of order [symbol] (tₘₐₓNML). Similarly, the computational complexity of existing linear inference algorithms is also of order [symbol] (tₘₐₓ^{SotA}NML), where tₘₐₓ^{SotA} is the total number of iterations of existing linear inference algorithms. And since both the proposed and existing JACE algorithms are based on the Bayesian message passing approach, the total number of iterations until convergence required by our method is comparable to those of existing alternatives (i.e. tₘₐₓ≈tₘₐₓ^{SotA}), such that we can conclude that the proposed algorithm has the same order of complexity of existing JACE methods. It will be shown in the sequel, however, that the proposed method outperform existing alternatives in terms of estimation accuracy, measured by NMSE and AER as defined in equations (41) and (42).

### Uniformly Random Non-Stationarity

Aiming at evaluating the fundamental performance improvement attained by the proposed JACE algorithm, it is considered in this subsection an XL-MIMO system subjected to uniformly random sub-array activity pattern. In other words, the sub-array activity indicators pₘₛ for all m and s are independently generated as a Bernoulli random variable, with the corresponding mean Φₛₘ set to be Φₛₘ=0.2, such that the number of the total active sub-arrays at each channel realization follows the Binomial distribution with order S, and 20% of the total subarrays are active at each channel realization in an average sense.

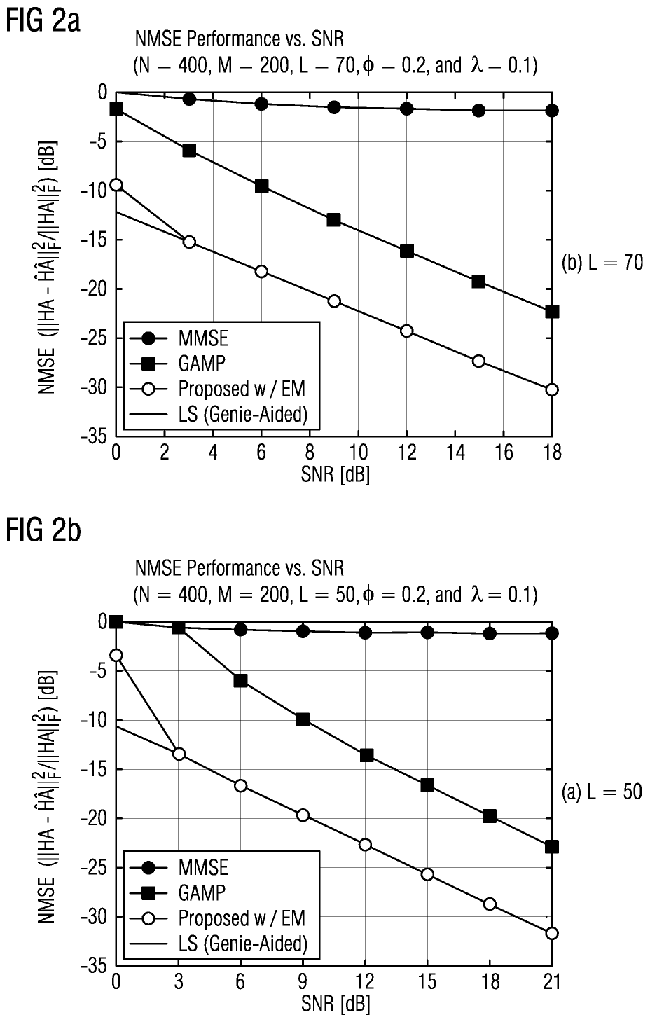

FIG. 2 shows the NMSE performance with respect to SNR with N=400 and M=200 for different pilot lengths. For the sake of comparison, two state-of-the-art methods are considered, namely the conventional linear minimum mean square error (MMSE) estimator, and an MMVABP scheme, which is a generalization of the multiple measurement vector approximate message passing (MMVAMP) algorithm. Comparing these three algorithms highlights performance gains due to awareness both to column-wise sparsity in the channel matrix resulting from grant free access, and to block-wise sparsity of active columns of the channel matrix, resulting from spatial nonstationarity. For instance, consider the comparison of NMSE performances of the three distinct algorithms as a function of SNR in decibels as shown in FIG. 2, for different pilot lengths (i.e., L∈{50, 70}), with pilot sequences designed via the quadratic complex sequential iterative decorrelation via convex optimization (QCSIDCO) algorithm in order to mitigate pilot contamination due to the non-orthogonal structure of X∈C^{M×L} with M>>L.

For the sake of a further reference, we also include curves (in solid line without markers) corresponding to lower-bounding NMSE performances obtained by the least square (LS) estimator aided by a genie, i.e with perfect knowledge of active user and sub-array activity indicators.

The FIG. 2 clearly illustrates the impact of the two distinct factors which impose structured sparsity upon the channel matrix. In particular, it can be seen that regardless of the length of the pilot sequence, the MMSE estimator suffers from a high error floor in terms of its NMSE performance, while the MMVABP algorithm improves as the SNR increases. The gains of MMVABP over the MMSE method is due to the awareness to column-wise sparsity in the channel matrix—i.e., awareness to user activity—which the MMVABP method incorporates, while the MMSE method does not. A a large gap exists between the performance of MMVABP and the lower-bound. In comparison to the latter two methods, the proposed method exhibits a substantial gain over the MMVABP approach, thanks to the fact that the proposed technique incorporates awareness not only to user activity, but also to the sub-array activity caused by spatial non-stationarity. As a result, the proposed method is found to actually reach the theoretical lower bound over a wide SNR range and starting from relatively low SNRs.

From these comments, one may conclude that the gain between the MMSE and the MMV-ABP methods results from awareness to user activity, while the gain between MMVABP and the proposed method is due to awareness to sub-array activity. It is also worth-mentioning that the sub-array activity indicators Φₛₘ are automatically learned for each channel realization via the EM framework presented in Section III-D, such that estimating such parameters before transmission is not necessary, contributing to improving the efficiency of the XL-MIMO system.

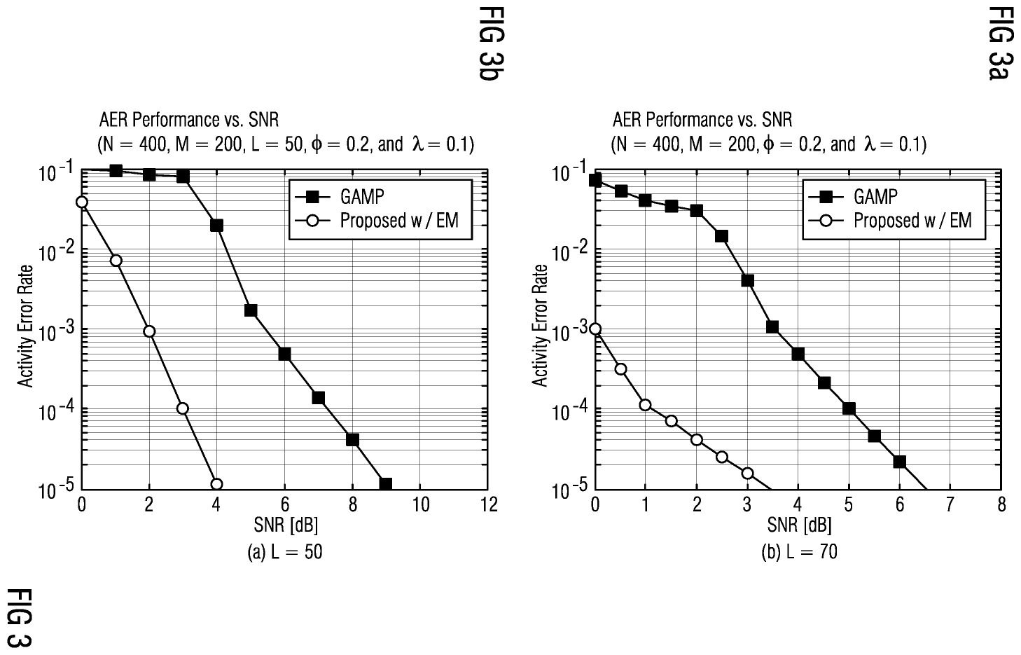

FIG. 3a, b shows the AER performance with respect to SNR with N=400 and M=200 for different pilot lengths. The AER performances of the proposed and the best state-of-the-art methods (namely, the MMVABP) are considered, omitting results for the MMSE scheme as it was found to be inferior to the latter. In addition, notice that showing Genie-aided lower bounding results is not useful, since the Genie-aided LS estimator has perfect knowledge of user and sub-array activities, such that AER performance is always 0.

The results are shown in FIG. 3 for different pilot lengths as done in FIG. 2. As expected, but interestingly, it is found that the proposed method significantly outperforms MMVABP also in terms of the AER performance. For instance, it can be seen that the relative AER gain of the proposed method over MMVABP is more than 4 [dB] in SNR at 10-5 of AER for both short and long pilot scenarios. In addition, it can be seen that the gradient of the AER curve of the proposed algorithm is steeper than that of the MMVABP approach.

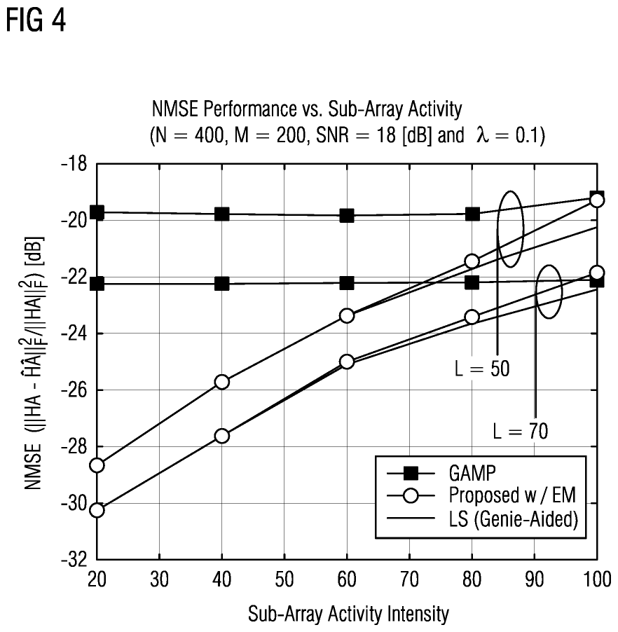

FIG. 4: shows the resilience of the proposed method against different sub-array activity indicators in percentage. Having clarified the NMSE and AER gains of the proposed method, the attention to resilience and convergence aspects of the proposed algorithm are taken in account. In FIG. 4 a comparison between the NMSE performance of the MMVABP, the Genie-aided LS, and the proposed estimators as a function of the sub-array activity indicators are proceeded. It has to be remarked that the channel is stationary at 100% sub-array intensity (i.e., at the right edge of the figure), while non-stationarity effects becomes severer as the sub-array intensity decreases. The results suggest that the proposed method is a generalization of the MMVABP method, capturing effects not only from the user activity but also from the sub-array activity. Thus, the performance of the proposed algorithm approaches that of MMVABP in case of a stationary channel (i.e., Φₛₘ=1), while offering significant gains over the latter as the non-stationarity increases.

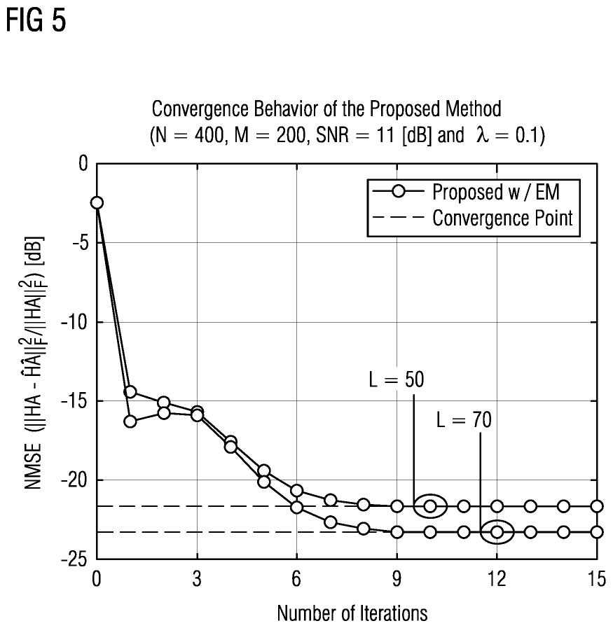

FIG. 5 shows the convergence behavior of the proposed algorithm with respect to the number of algorithmic iterations. In FIG. 5, the convergence behavior of the proposed algorithm as a function of the number of the algorithmic iterations for different pilot lengths is illustrated. It is shown in the figure that although a relatively large value for the maximum number of iterations (t=32) are assumed, the algorithm converges within 10 iterations under both pilot lengths considered. This implies that the total complexity of the method commented in Subsection IV-A can be further reduced (by more than a half) by setting a certain convergence criterion.

### Matern-Cluster Point Process Based Non-Stationarity

The comparison results shown in the previous subsections serve the purpose of quantifying the gains achievable by the proposed method over state-of-the-art alternatives, which stem in particular from the ability of the contributed scheme to detect both user and sub-array activity. It can be argued, however, that the uniformly random sub-array activity pattern is somewhat artificial, since in realistic scenarios, such patterns are characterized by VRs. Indeed, in practice the likelihood of activation of a certain sub-array is highly correlated with that of neighboring sub-arrays, such that VRs tend to occur in clusters. In this subsection, a repetition of the test reported above, utilizing this time a stochastic geometry approach to model the aforementioned geometrical correlation among the activity indicators of sub-arrays, so as to mimic the cluster-like nature of VRs, as illustrated in FIG. 1. To this end, the Matern-cluster point process (MCPP) is considered—not to be confused with Matern hardcore point process—to model the non-stationarity effects ' in XL-MIMO systems.

In order to bring MCPP into the simulation setup, we consider a rectangular area in which sub-arrays are placed following an equispaced grid. Within this area, MCPP is leveraged to generate random clusters with a constant radius r and centers following a homogeneous Poisson point process (PPP) with an intensity μ. Each cluster generated by MCPP is regarded as a VR, and therefore, sub-arrays located in the clusters are considered active, whereas sub-arrays located outside the clusters are assumed to be inactive.

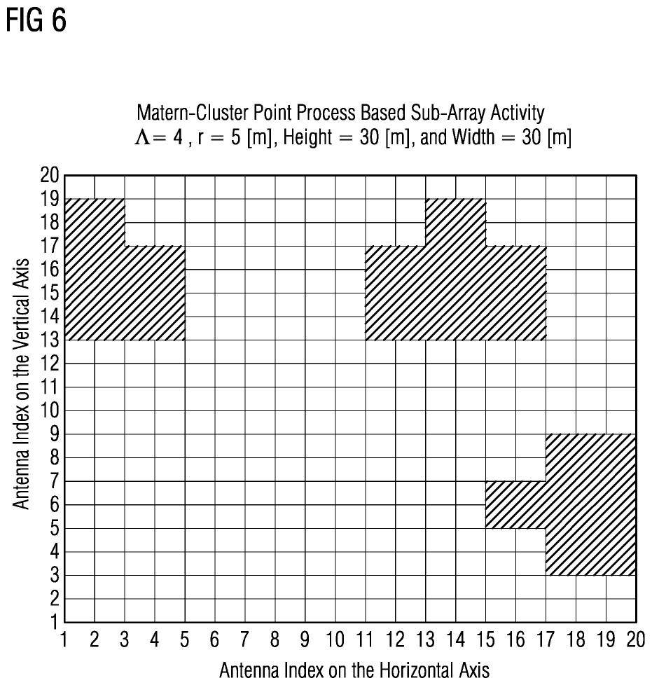

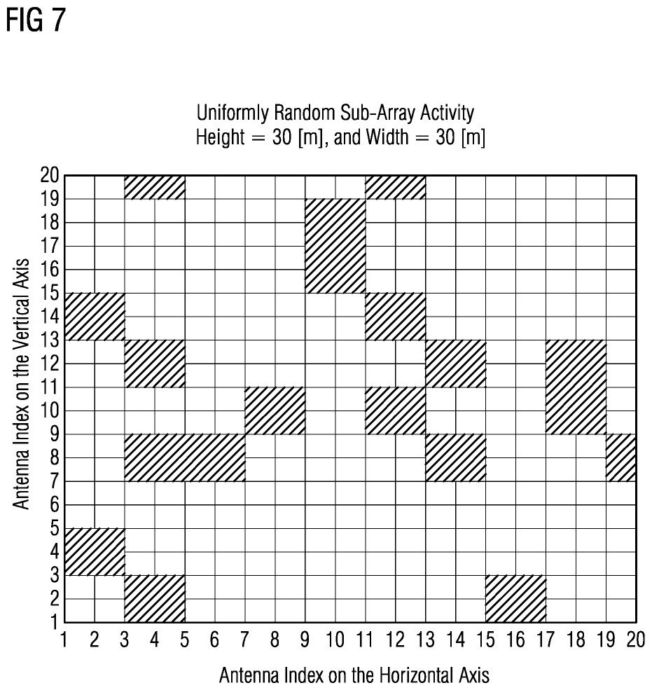

FIG. 6 shows the MCPP-based subarray activity and FIG. 7 shows the uniformly random subarray activity. To visualize the difference between MCPP-based and uniformly random non-stationarity models, in FIGS. 6 and 7 a comparison of sub-array activity patterns for the two different models for a given realization is given, with the number of active antennas set to be identical in both cases. In the figures, white and black squares indicate inactive and active antennas, respectively, where we assumed a 2×2 square sub-array, Height=30 [m], Width=30 [m], μ=4 and r=5. One can observe from the figures that the MCPP-based approach clearly illustrates clustered VRs, capturing more realistically the behavior of the non-stationarity, while the uniformly random counterpart shows a more scattered distribution of VRs

With the stochastic-geometric VR generation model described, we proceed to the performance assessment of the JACE algorithms under this MCPP-based non-stationarity model. In this section, we evaluate the estimation performance of the proposed method in comparison with the two state-of-the-art estimators as well as the Genie-aided ideal performance for different cluster setups, by considering different cluster intensities μ and the radius r and studying the impact of both parameters on the detection performance.

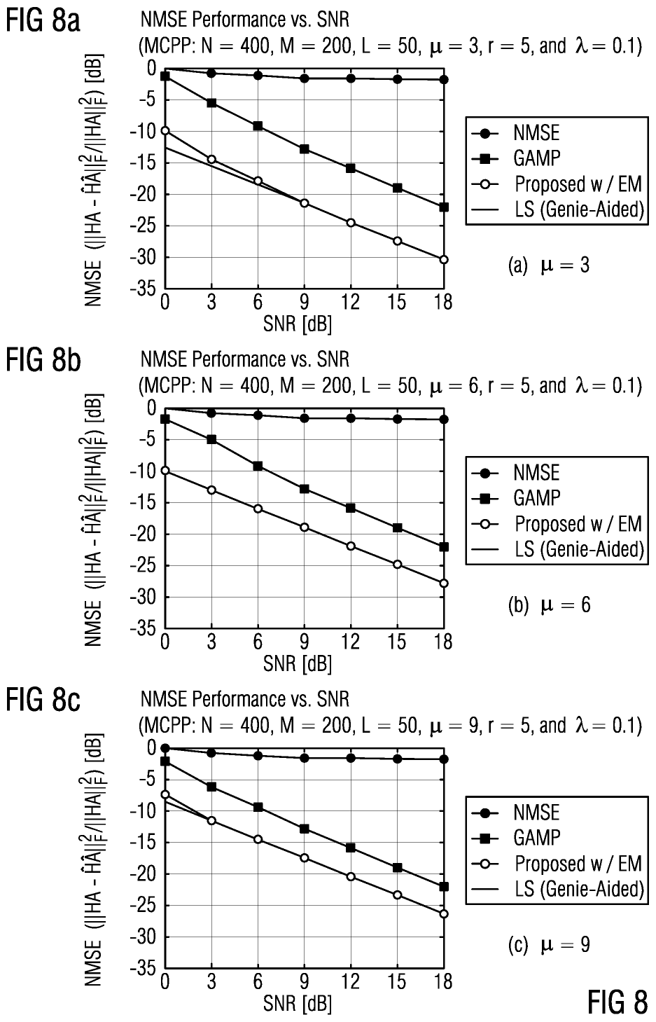

FIG. 8a, b, c shows the NMSE Performance with respect to SNR with N=400, M=200, and L=70 with MCPP for different μ. In FIG. 8 the NMSE performances of the three distinct detection algorithms are compared for different cluster intensities μ and a fixed radius size r=5 [m], with the Genie-aided ideal performance also included for reference. As expected based on the previous results of FIGS. 2 and 4, the proposed method outperforms both the MMVABP and the conventional linear MMSE methods, although the performance gain diminishes slightly as the cluster intensity increases, which is expected since with for larger cluster intensities the number of active subarrays itself grows. It is also observed that once again the proposed algorithm reaches the Genie-aided ideal performance for a wide range of SNR regardless of the cluster intensity level.

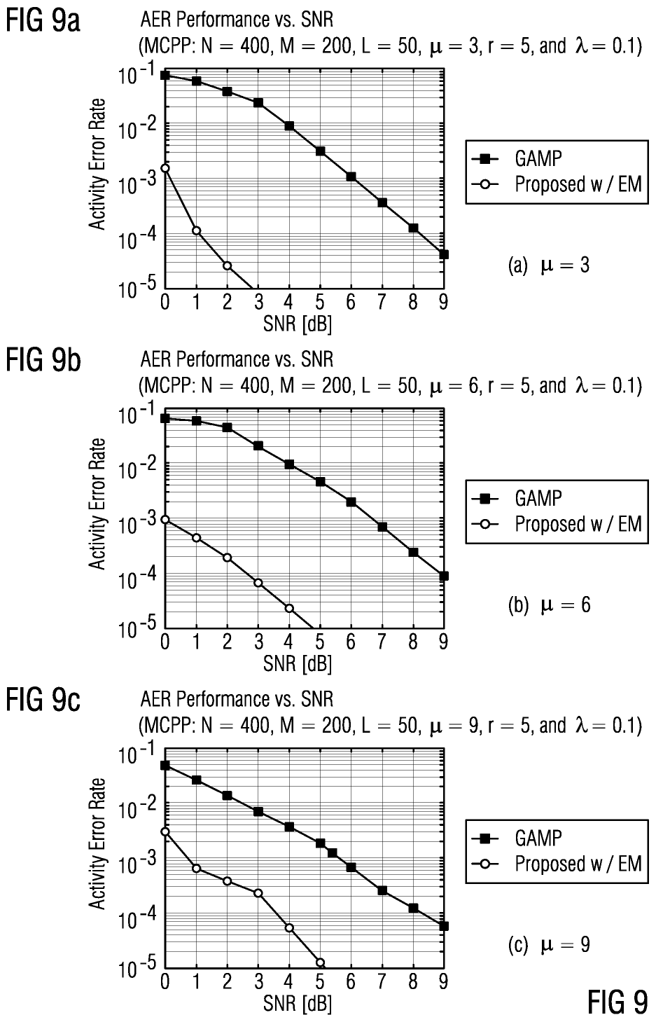

FIG. 9a, b, c shows the AER Performance with respect to SNR with N=400, M=200, and L=70 with MCPP for different μ. In FIG. 9 the AER performance of the proposed algorithm against that of the MMVABP scheme is compared, again for different cluster intensity levels and as a function of SNR. The figure confirms that the proposed method is effective also in terms of the AER performance.

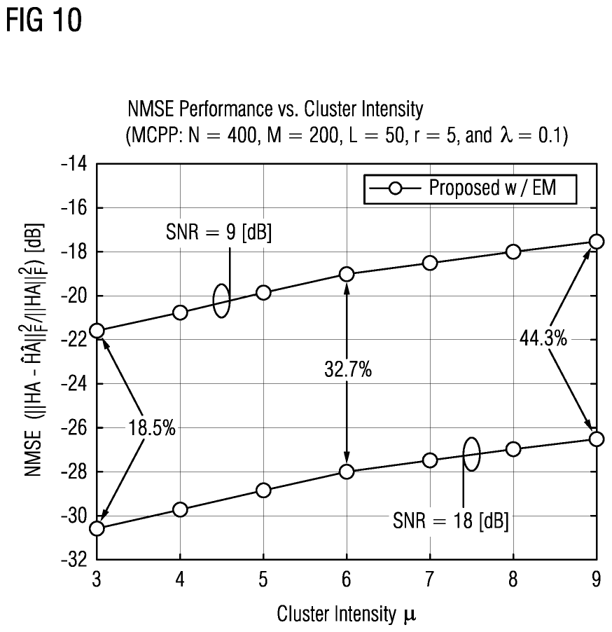

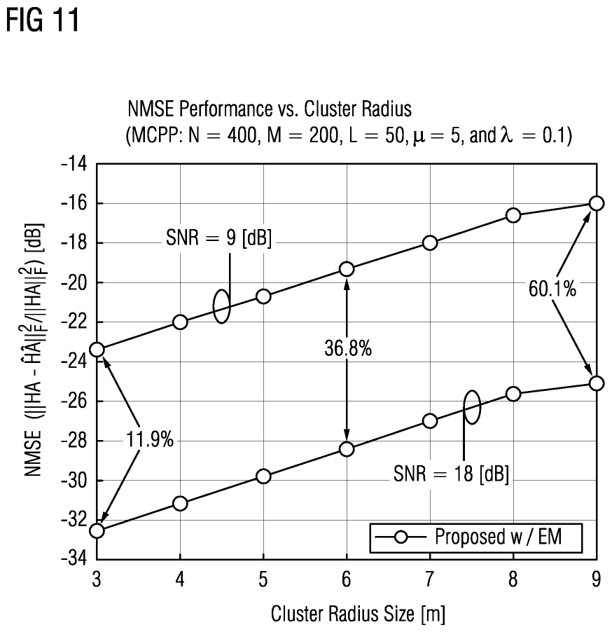

FIG. 10 shows the NMSE performance of the proposed method for different cluster intensities. The actual array activity ratios for μ=3, 6 and 9 are annotated by allows. FIG. 11 shows the NMSE performance of the proposed method for different cluster radius sizes. The actual array activity ratios for μ=3, 6 and 9 are annotated by allows.

Having shown the effectiveness of the proposed algorithm even in case of clustered sub-array activity, in FIGS. 10 and 11 the NMSE performance of the proposed algorithm as a function of cluster intensity μ and radius r, respectively, for two different SNR levels are calculated. For ease of interpretation of the results, the actual sub-array activity ratios, defined as the ratio between the number of active sub-arrays and the total number of sub-arrays, are annotated by arrows for μ=3, 6 and 9. The figures illustrate the fact that the performance of the proposed JACE algorithm is mostly dependent on the actual activity indicator, rather than the shape of clusters, implying an inherent robustness against the nature of the spatial non-stationarity.

In this application, a solution of JACE problem in grant-free uplink XL-MIMO systems subject to spatial non-stationarity is solved, where the user activity and the sub-array activity jointly impose structured sparsity onto the channel matrix. For such a system, a new system model is introduced in order to characterize the structured sparsity of the channel, formulating the estimation problem of a variable following a nested Bernoulli-Gaussian distribution. To tackle this intractable estimation problem, we a novel estimation method is proposed based on the bilinear Bayesian inference framework, deriving all the updates in closed-form. The proposed method possesses linear complexity with respect to the dimensions of the receive antenna array, number of users, and time resources, respectively. In order to numerically study the benefits of the proposed method, performance assessments via Monte-Carlo simulations, revealing the effectiveness of the proposed algorithm in terms of the NMSE and AER performance indicators were evaluated. This application also reports one of the first attempts to adopt stochastic geometry (SG) to model the clustered nature of the partial observations at XL-MIMO arrays due to spatial non-stationarity. In particular, the MCPP to model such observed clusters are proposed, showing the superiority of the proposed method regardless of the cluster size, intensity, and sub-array activity ratio.

1. Method A method for modeling visible clusters and non-stationarities in XL-MIMO systems, the method comprising:
configuring a plurality of transmit antennas to each represent an in-phase spatial constellation symbol within an in-phase spatial constellation, and a quadrature spatial constellation symbol within a quadrature spatial constellation,
mapping source data to the in-phase spatial constellation symbols and the quadrature spatial constellation symbols represented by the plurality of transmit antennas, wherein the Matérn-cluster point process, which models randomly located clusters within a given area, defines the area where antenna arrays are embedded.

2. The method of claim 1 characterized by a modification to the iterative shrinkage-thresholding algorithm (ISTA) via boxing with range limiting and hard-thresholding is proceeded.

3. The method of claim 1, using the boxed-hard iterative shrinkage-thresholding algorithm (ISTA), a greedy selection of the positions of the antennas index and the symbol estimates, and their independent decoding of the corresponding antenna modulated and symbol modulated bits is determined.

4. The method of claim 3, wherein process working parallel to the greedy detections, to ensure valid estimates of the index vectors from the given finite set of index vectors are produced at the output of the method, and to apply interference cancellation with the confirmed values,
while keeping track of which indices have been retrieved from the greedy selections, before every iteration a check is performed whether from the currently decoded indices, a final confirmation can be made,
if the final confirmation cannot be made, remove the interference by the previous greedy selection and the next iteration is proceeded.

5. A receiver of a communication system having a processor, volatile and/or non-volatile memory, at least one interface adapted to receive a signal in an communication channel, wherein the non-volatile memory stores computer program instructions which, when executed by the microprocessor, configure the receiver to perform operations comprising:
configuring a plurality of transmit antennas to each represent an in-phase spatial constellation symbol within an in-phase spatial constellation, and a quadrature spatial constellation symbol within a quadrature spatial constellation,
mapping source data to the in-phase spatial constellation symbols and the quadrature spatial constellation symbols represented by the plurality of transmit antennas, wherein the Matérn-cluster point process, which models randomly located clusters within a given area, defines the area where antenna arrays are embedded.

6. (canceled)

7. (canceled)

8. The receiver of claim 5 characterized by a modification to the iterative shrinkage-thresholding algorithm (ISTA) via boxing with range limiting and hard-thresholding is proceeded.

9. The receiver of claim 5, using the boxed-hard iterative shrinkage-thresholding algorithm (ISTA), a greedy selection of the positions of the antennas index and the symbol estimates, and their independent decoding of the corresponding antenna modulated and symbol modulated bits is determined.

10. The receiver of claim 9, wherein process working parallel to the greedy detections, to ensure valid estimates of the index vectors from the given finite set of index vectors are produced at the output of the method, and to apply interference cancellation with the confirmed values,
while keeping track of which indices have been retrieved from the greedy selections, before every iteration a check is performed whether from the currently decoded indices, a final confirmation can be made,
if the final confirmation cannot be made, remove the interference by the previous greedy selection and the next iteration is proceeded.
